(19) United States
(12) Patent Application Publication
(10) Pub. No.: US 2026/0019214 A1
(43) Pub. Date: Jan. 15, 2026

(54) Wireless Communication Method and Communication Device

(71) Applicant: GUANGDONG OPPO MOBILE TELECOMMUNICATIONS CORP., LTD., Dongguan (CN)

(72) Inventors: Yapu LI, Dongguan (CN); Chaoming LUO, Dongguan (CN); Ning GAO, Dongguan (CN); Liuming LU, Dongguan (CN)

(73) Assignee: GUANGDONG OPPO MOBILE TELECOMMUNICATIONS CORP., LTD., Dongguan (CN)

(21) Appl. No.: 19/334,654

(22) Filed: Sep. 19, 2025

Related U.S. Application Data
(63) Continuation of application No. PCT/CN2023/139794, filed on Dec. 19, 2023.

(51) Int. Cl. H04L 5/00

(52) U.S. Cl. CPC H04L 5/0057

(57) ABSTRACT

A wireless communication method is provided. The method includes: transmitting, by a first device, a first frame to a second device. A communication device is provided. The communications device is a first device, and the communications device comprises a memory and a processor, where the memory is configured to store a computer program and the processor is configured to execute the computer program stored in the memory to cause the communication device to perform an operation of: transmitting a first frame to a second device.

### CROSS-REFERENCE TO RELATED APPLICATIONS

This application is a continuation of International Application No. PCT/CN2023/139794, filed on Dec. 19, 2023, the disclosure of which is hereby incorporated by reference in its entirety.

### TECHNICAL FIELD

This application relates to the field of communications technologies, and more specifically, to a wireless communication method and a communications device.

### BACKGROUND

With the development of technologies, a resource unit (RU) may have not only consecutive subcarriers but also inconsecutive subcarriers. An RU having consecutive subcarriers may be referred to as a regular RU (rRU). An RU having inconsecutive subcarriers may be referred to as a distributed RU (dRU). In a dRU mode, a transmission rate is relatively low.

### SUMMARY

This application provides a wireless communication method and a communications device. The following describes various aspects of this application.

According to a first aspect, a wireless communication method is provided. The method includes: transmitting, by a first device, a first frame to a second device, where the first frame is used to initiate dRU-based sounding feedback.

According to a second aspect, a wireless communication method is provided. The method includes: receiving, by second device, a first frame transmitted by a first device, where the first frame is used to initiate dRU-based sounding feedback.

According to a third aspect, a communications device is provided. The communications device is a first device and includes: a transmitting unit, configured to transmit a first frame to a second device, where the first frame is used to initiate dRU-based sounding feedback.

According to a fourth aspect, a communications device is provided. The communications device is a second device and includes: a receiving unit, configured to receive a first frame transmitted by a first device, where the first frame is used to initiate dRU-based sounding feedback.

According to a fifth aspect, a communications device is provided. The communications device includes a processor and a memory. The memory is configured to store one or more computer programs. The processor is configured to invoke the computer program in the memory, to cause the communications device to perform some or all of the steps of a method according to the foregoing aspects.

According to a sixth aspect, an embodiment of this application provides a communications system. The communications system includes the foregoing communications device. In another possible design, the system may further include another device that interacts with the communications device in a solution provided in this embodiment of this application.

According to a seventh aspect, an embodiment of this application provides a computer-readable storage medium. The computer-readable storage medium stores a computer program, and the computer program causes a communications device to perform some or all of the steps in a method according to the foregoing aspects.

According to an eighth aspect, an embodiment of this application provides a computer program product. The computer program product includes a non-transitory computer-readable storage medium storing a computer program, and the computer program is operable to cause a communications device to perform some or all of the steps of a method according to the foregoing aspects. In some implementations, the computer program product may be a software installation package.

According to a ninth aspect, an embodiment of this application provides a chip. The chip includes a memory and a processor. The processor may invoke a computer program from the memory and run the computer program, to implement some or all of the steps described in a method according to the foregoing aspects.

### BRIEF DESCRIPTION OF DRAWINGS

FIG. 1 is a schematic diagram of a wireless communications system to which an embodiment of this application is applied.

FIG. 2 is an example diagram of a non-trigger-based sounding process.

FIG. 3 is an example diagram of a trigger-based sounding process.

FIG. 4A is an example diagram of a format of a null data physical layer protocol data unit announcement (NDPA) frame.

FIG. 4B is an example diagram of a format of a sounding dialog token field.

FIG. 4C is an example diagram of a format of an extremely high throughput (EHT) NDPA frame.

FIG. 4D is an example diagram of a format of a station information (STA info) field in an EHT NDPA frame.

FIG. 5 is an example diagram of a scenario in which dRU transmission is used.

FIG. 6 is a schematic flowchart of a wireless communication method according to an embodiment of this application.

FIG. 7A is a schematic diagram of a format of a station information field according to an embodiment of this application.

FIG. 7B is a schematic diagram of a format of another station information field according to an embodiment of this application.

FIG. 8 is a schematic flowchart of a wireless communication method according to Embodiment 1.

FIG. 9 is a schematic structural diagram of a communications device according to an embodiment of this application.

FIG. 10 is a schematic structural diagram of another communications device according to an embodiment of this application.

FIG. 11 is a schematic structural diagram of an apparatus used for communication according to an embodiment of this application.

### DESCRIPTION OF EMBODIMENTS

The following describes technical solutions in this application with reference to the accompanying drawings.

### Communications System

The technical solutions in embodiments of this application may be applied to various communications systems, for example, a wireless local area network (WLAN), wireless fidelity (wireless fidelity, WiFi), a high performance radio local area network (HIPELAN), a wide area network (WAN), a cellular network, or another communications system. For another example, the technical solutions in the embodiments of this application may be applied to a communications systems using the 802.11 standard. For example, the 802.11 standard includes but is not limited to the 802.11ax standard, the 802.11be standard, a next generation 802.11 standard, or the like.

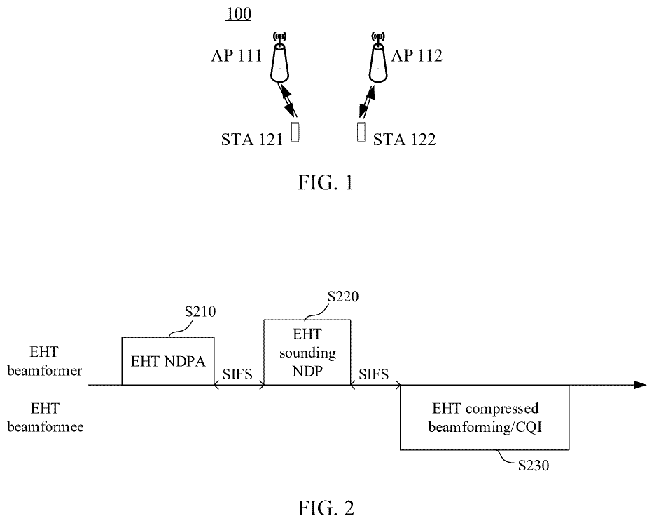

FIG. 1 is a schematic diagram of a communications system to which an embodiment of this application is applied. With reference to FIG. 1, a communications device in the communications system 100 may include an access point (AP) 111, an AP 112, a station (STA) 121, and an STA 122, where the STA 121 may access a network through the AP 111, and the STA 122 may access the network through the AP 112.

In some implementations, an STA may establish an association relationship with one or more APs. Then, the STA and the AP that have an association relationship may communicate with each other. With reference to FIG. 1, the AP 111 and the STA 121 may communicate with each other after an association relationship is established therebetween; and the AP 112 and the STA 122 may communicate with each other after an association relationship is established therebetween.

In some implementations, communication in the communications system 100 may be communication between an AP and a non-AP STA, or may be communication between one non-AP STA and another non-AP STA, or communication between an STA and a peer STA, where the peer STA may refer to a device that performs peer-to-peer communication with the STA, for example, the peer STA may be an AP, or may be a non-AP STA.

It should be understood that FIG. 1 exemplarily shows two AP STAs and two non-AP STAs. Alternatively, the communications system 100 may include more AP STAs, or the communications system 100 may include another quantity of non-AP STAs. This is not limited in embodiments of this application.

In addition, the foregoing communications system may be applied to scenarios of multi-device collaboration, for example, a scenario of multiple-access point (multiple access points, Multi-AP) collaboration, a scenario of multi-station collaboration, or the like.

Names of the AP and/or STA are not limited in embodiments of this application. In some scenarios, an AP may also be referred to as an AP STA. In other words, in a sense, the AP is also an STA. In some other scenarios, an STA may also be referred to as a non-AP STA (non-AP STA).

In some scenarios, the foregoing communications device may alternatively be a “multi-link device (MLD)”, namely, a device that performs communication through a plurality of communications links. The plurality of communications links may include communications links of different frequency bands, for example, may include a millimeter-wave frequency band and/or a low frequency band. Generally, if the multi-link device is an AP, the AP may also be referred to as a “multi-link AP”; and if the multi-link device is an STA, the STA may also be referred to as a “multi-link STA”.

In embodiments of this application, the AP may be a device in a wireless network. The AP may be a communications entity, for example, a communications server, a router, a switch, a network bridge, or the like; or the AP device may include various forms of macro base stations, micro base stations, relay stations, or the like. Certainly, the AP may alternatively be a chip, a circuit, or a processing system in these various forms of devices, to implement a method and a function in embodiments of this application. The AP device may be applied to a variety of scenarios, for example, a sensor node in a smart city (for example, a smart water meter, a smart electricity meter, or a smart air detection node), a smart device in a smart home (for example, a smart camera, a projector, a display screen, a TV, a speaker, a refrigerator, a washing machine, or the like), a node in the Internet of Things, an entertainment terminal (for example, a wearable device such as AR or VR), a smart device in a smart office (for example, a printer, a projector, or the like), a vehicle-to-everything device in the Internet of Vehicles, some infrastructure in daily life scenarios (for example, a vending machine, a self-service navigation station in a shopping mall or supermarket, a self-service cashier device, or a self-ordering kiosk), or the like.

In some implementations, a role of the STA in the communications system is not fixed. In some scenarios, the STA may serve as an AP. For example, in a scenario in which a mobile phone is connected to a route, the mobile phone may be a non-AP STA; in a case that the mobile phone serves as a hotspot of another mobile phone, the mobile phone acts as an AP.

An STA device in embodiments of this application may be a device having a wireless transceiver function, for example, may be a device that supports protocols 802.11 series and may communicate with an AP or another STA. For example, the STA is any communications device of a user that allows the user to communicate with an AP and then communicate with WLAN. For example, the STA device is: a user equipment (UE), a mobile station (MS), a mobile terminal (MT), an access terminal, a subscriber unit, a subscriber station, a remote station, a remote terminal, a mobile device, a user terminal, a terminal, a wireless communications device, a user agent, a user apparatus, or the like.

The STA in embodiments of this application may alternatively be a device providing a user with voice/data connectivity, for example, a handheld device, a vehicle-mounted device, or the like having a wireless connection function. For example, the STA is a mobile phone, a tablet computer, a notebook computer, a palmtop computer, a mobile Internet device (MID), a wearable device, a virtual reality (VR) device, an augmented reality (AR) device, a wireless terminal in industrial control, a wireless terminal in self driving, a wireless terminal in remote medical surgery, a wireless terminal in a smart grid, a wireless terminal in transportation safety, a wireless terminal in a smart city, a wireless terminal in a smart home, a cellular phone, a cordless phone, a session initiation protocol (SIP) phone, a wireless local loop (WLL) station, a personal digital assistant (PDA), a handheld device with a wireless communication function, a computing device or another processing device connected to a wireless modem, a vehicle-mounted device, a wearable device, a terminal device in a future 5G network, a terminal device in a future evolved public land mobile network (PLMN) network, or the like. This is not limited in embodiments of this application.

By way of example rather than limitation, in embodiments of this application, the STA device may alternatively be a wearable device. The wearable device may also be referred to as a smart wearable device, and is a general term for wearable devices, such as glasses, gloves, watches, clothes, and shoes, that are intelligently designed and developed based on daily wearing by using a wearable technology. For example, the wearable device is a smart watch or smart glasses, or a device that focuses on only a specific type of application function and is required to cooperate with another device such as a smart phone for use, for example, various smart bracelets, smart jewelries, or the like for physical sign monitoring.

In addition, in embodiments of this application, the STA device may alternatively be a terminal device in an Internet of Things (IoT) system. The IoT is an important component of future development of information technologies, and a main technical feature of the IoT is that objects are connected to a network by using a communication technology, to implement an intelligent network of human-computer interconnection and interconnection of things. In embodiments of this application, the IoT technology may implement mass connection, intensive coverage, and terminal power saving by using a narrow band (NB) technology or the like.

In addition, in embodiments of this application, the STA device may be a device in a vehicle-to-everything system. Communication methods in the vehicle-to-everything system are collectively referred to as V2X (where X represents everything). For example, the V2X communication includes: vehicle to vehicle (V2V) communication, vehicle to roadside infrastructure (vehicle to infrastructure, V2I) communication, vehicle to pedestrian (V2P) communication, vehicle to network (V2N) communication, or the like.

In addition, in embodiments of this application, the STA device may further include sensors such as a smart printer, a train detector, a gas station, or the like. Main functions of the device include: data collection (some terminal devices), receiving of control information and downlink data of the AP device, transmitting of an electromagnetic wave, and transmission of data to the AP.

In addition, the AP device in embodiments of this application may be a device for communicating with the STA device. The AP device may be a network device in a wireless local area network. The AP device may be configured to communicate with the STA device through the wireless local area network.

From the perspective of a communication standard supported by an AP, in some implementations, the AP may be a device that supports the 802.11be standard. The AP may alternatively be a device that supports a plurality of current and future WLAN standards of the 802.11 family, such as 802.11ax, 802.11ac, 802.11n, 802.11g, 802.11b, and 802.11a.

From the perspective of a communication standard supported by an STA, in some implementations, the non-AP STA may support the 802.11be standard. The non-AP STA may also support a plurality of current and future wireless local area network (WLAN) standards of the 802.11 family, such as 802.11ax, 802.11ac, 802.11n, 802.11g, 802.11b, and 802.11a.

Frequency bands supported in a WLAN technology are not limited in embodiments of this application. In some implementations, the frequency bands supported in the WLAN technology may include but are not limited to a low frequency band (for example, 2.4 GHz 5 GHz, or 6 GHz) and a high frequency band (for example, 45 GHz or 60 GHz).

It should be understood that specific forms of the STA device and the AP device are not specially limited in embodiments of this application and are only described exemplarily herein.

### Sounding

Communications technologies, such as transmit beamforming, MIMO (for example, downlink multi-user multiple-input multiple-output (DL MU-MIMO)), or the like, require information about a channel state to compute a steering matrix that is applied to transmitting of a signal, thereby optimizing reception of one or more receivers. Some communications devices (for example, an EHT STA) use a sounding protocol to determine channel state information. The following describes sounding protocols by using an EHT sounding protocol as an example.

The EHT sounding protocol provides an explicit feedback mechanism. This mechanism may include two sounding sequences. The two sounding sequences are an EHT non-trigger-based sounding sequence (EHT non-TB sounding sequence) and an EHT trigger-based sounding sequence (EHT TB sounding sequence), respectively. In the two sounding sequences, an EHT beamformee uses a training signal transmitted by an EHT beamformer for measuring a channel. The training signal may include an EHT sounding null data physical layer protocol data unit (NDP). Further, the EHT beamformee may feed back the channel state transition estimation. The EHT beamformer may use this estimation to determine the steering matrix.

Feedback from the EHT beamformee may be carried in an EHT compressed beamforming/CQI report in one or more EHT compressed beamforming/channel quality indicator (CQI) frames.

The EHT compressed beamforming/CQI report may include the following three types: single user feedback (SU feedback), multiple user feedback (MU feedback), and CQI feedback (CQI feedback). Fields included in different types of EHT compressed beamforming/CQI reports are different, and are described below separately.

In single user feedback, an EHT compressed beamforming/CQI report may include an EHT compressed beamforming/CQI report field.

In multiple user feedback, a compressed beamforming/CQI report may include a compressed beamforming/CQI report field and an EHT multiple user exclusive beamforming report (EHT MU exclusive beamforming report) field.

In CQI feedback, a compressed beamforming/CQI report may include an EHT CQI report field.

Formats of 20 MHz compressed beamforming may be as shown in Table 1.

TABLE 1

| Field | Size (unit: bits) | Meaning |
|---|---|---|
| SNR in space-time | 8 | Average signal-to-noise |
| stream 1 | | ratio in the STA sending |
| | | the report for space-time |
| | | stream 1 |
| . . . | | |
| SNR in space-time | 8 | Average signal-to-noise |
| stream Nc | | ratio in the STA sending |
| | | the report for space-time |
| | | stream Nc |
| Beamforming feedback | Nₐ × (b_{Ψ} + b_{ϕ})/2 | Beamforming feedback |
| matrix V for carrier-28 | | matrix V |
| . . . | | |
| Beamforming feedback | Nₐ × (b_{Ψ} + b_{ϕ})/2 | Beamforming feedback |
| matrix V for carrier-1 | | matrix V |
| Beamforming feedback | Nₐ × (b_{Ψ} + b_{ϕ})/2 | Beamforming feedback |
| matrix V for carrier 1 | | matrix V |
| . . . | | |
| Beamforming feedback | Nₐ × (b_{Ψ} + b_{ϕ})/2 | Beamforming feedback |
| matrix V for carrier 28 | | matrix V |

The following describes the non-trigger-based sounding sequence and the trigger-based sounding sequence.

### Non-Trigger-Based Sounding Sequence

FIG. 2 is an example diagram of a non-trigger-based sounding process. The process shown in FIG. 2 may be performed by one EHT beamformer and one EHT beamformee. The process shown in FIG. 2 may include steps S210 to S230.

In step S210, the EHT beamformer transmits an EHT NDPA frame. It should be noted that the NDPA frame may also be referred to as an NDP announcement frame.

The NDPA frame may be an individually addressed NDPA frame.

The EHT NDPA frame includes only a station information field (STA info field). It may be learned that the EHT beamformer may initiate the non-trigger-based sounding sequence with the EHT beamformee, to request single user (SU) or CQI feedback.

Based on step S210, the EHT beamformer may initiate an EHT non-trigger-based sounding sequence.

In step S220, the EHT beamformer transmits an EHT sounding NDP frame in a short interframe space (SIFS) after the EHT NDPA frame.

In step S230, the EHT beamformee responds to an EHT compressed beamforming/CQI frame in an SIFS after the EHT sounding NDP frame.

### Trigger-Based Sounding Sequence

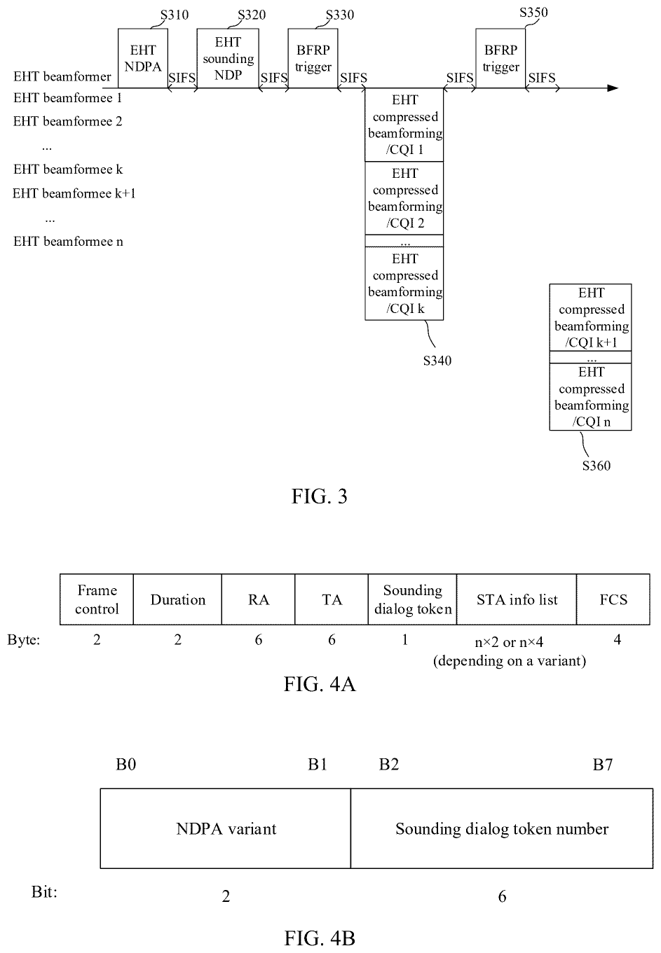

FIG. 3 is an example diagram of a trigger-based sounding process. The process shown in FIG. 3 may be performed by one EHT beamformer and n EHT beamformees (n≥1). The process shown in FIG. 3 may include steps S310 to S340.

In step S310, the EHT beamformer transmits an EHT NDPA frame.

Based on step S310, the EHT beamformer may initiate an EHT trigger-based sounding sequence.

The EHT NDPA frame in step S310 may include one or more station information fields.

In step S320, the EHT beamformer transmits an EHT sounding NDP frame in an SIFS after the EHT NDPA frame.

In step S330, the EHT beamformer transmits a beamforming report poll (BFRP) trigger frame (BFRP trigger frame) in an SIFS after the EHT sounding NDP frame.

A quantity of stations that may be triggered by the BFRP trigger frame in step S330 may be limited. In FIG. 3, the BFRP trigger frame triggering k stations for feedback in step S330 is used as an example, where k is a positive integer less than or equal to n.

In step S340, in response to the BFRP trigger frame, the EHT beamformee 1 to the EHT beamformee k simultaneously feed back EHT compressed beamforming/CQI frames.

It should be noted that each beamformee triggered by the BFRP trigger frame may respond to an EHT TB physical layer protocol data unit (PPDU) in an SIFS after the BFPR trigger frame, where the PPDU may include one or more EHT compressed beamforming/CQI frames.

In a case that k<n, the EHT TB sounding sequence may further include a subsequent BFRP trigger frame, that is, the process shown in FIG. 3 may further include steps S350 and S360. In step S350, the EHT beamformer transmits the subsequent BFRP trigger frame.

In step S360, in response to the BFRP trigger frame in step S350, the EHT beamformee k+1 to the EHT beamformee n simultaneously feed back EHT compressed beamforming/CQI frames.

It should be noted that if the EHT TB sounding sequence includes the subsequent BFRP trigger frame (for example, the BFRP trigger frame in step S350), the beamformer should transmit the subsequent BFRP trigger frame in an SIFS after the EHT TB PPDU is transmitted in response to the previous BFRP trigger frame.

It should be noted that using EHT trigger-based sounding does not necessarily imply multiple user feedback. EHT trigger-based sounding may also be used to obtain single user feedback or CQI feedback.

It should be noted that the above is described by using the EHT sounding process as an example. However, this application may be applied not only to an EHT sounding process, but also to other sounding processes (for example, a very high throughput (VHT) sounding process, a high efficiency (HE) sounding process, an ultra high reliability (UHR) sounding process, or the like). Principles of these sounding processes are similar, and thus details are not repeated.

It may be learned from the above that in both trigger-based sounding and non-trigger-based sounding, the beamformer is required to transmit an NDPA frame. The following describes the NDPA frame.

### NDPA Frame

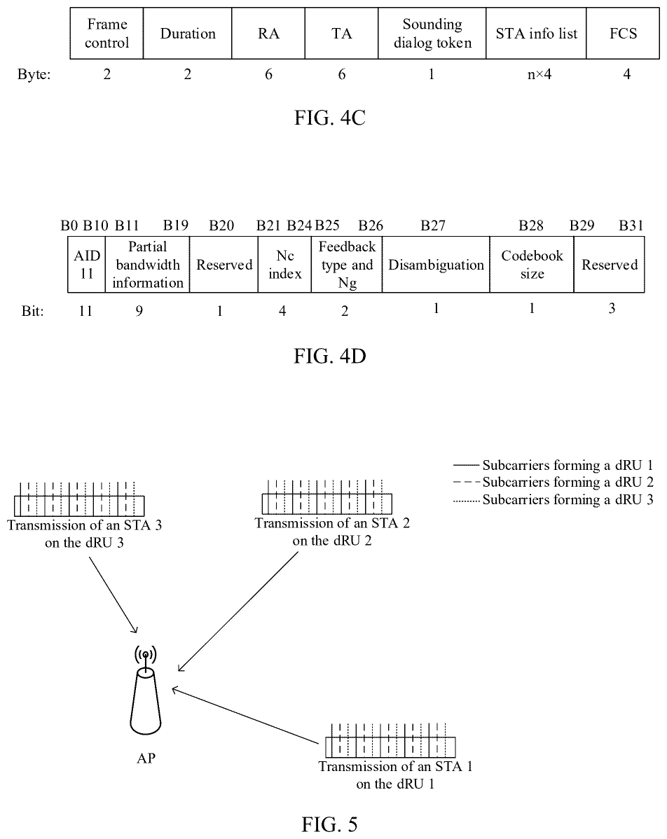

FIG. 4A is an example diagram of a format of an NDPA frame. As shown in FIG. 4A, the NDPA frame may include one or more of the following fields: frame control, duration, receive-end address (RA), transmit-end address (transmission address, TA), sounding dialog token, station information list (STA info list), or frame check sequence (FCS).

FIG. 4B is an example diagram of a format of a sounding dialog token field. As shown in FIG. 4B, the sounding dialog token field may include one or more of the following fields: NDPA variant (NDP announcement variant) or sounding dialog token number.

The NDPA variant field may be used to indicate an NDPA variant. In a related technology, an NDPA frame may include four variants. The 4 variants are a VHT NDPA frame (VHT NDP announcement frame), an HE NDPA frame (HE NDP announcement frame), a ranging (ranging) NDPA frame (ranging NDP announcement frame), and an EHT NDPA frame (EHT NDP announcement frame), respectively. Table 2 exemplarily shows variants corresponding to NDPA variant values.

TABLE 2

| NDPA variant subfield | NDPA frame variant |
|---|---|
| (NDP Announcement | (NDP Announcement |
| Variant subfield) | frame variant) |
| 0 | VHT NDPA frame |
| 1 | Ranging NDPA frame |
| 2 | HE NDPA frame |
| 3 | EHT NDPA frame |

FIG. 4C is an example diagram of a format of an EHT NDPA frame, that is, FIG. 4C shows a format of an NDPA frame whose NDPA variant subfield is equal to 3.

A station information list field in the NDPA frame may include one or more station information (STA info) fields. FIG. 4D is an example diagram of a format of a station information field in an EHT NDPA frame.

As shown in FIG. 4D, the station information field may include one or more of the following fields: AID 11, partial bandwidth information (partial BW info), reserved, Nc index, feedback type and Ng, disambiguation, or codebook size, which are described below separately.

The partial bandwidth information field may be used to indicate a size of a feedback RU or MRU. Table 3 exemplarily shows codes of partial bandwidth information fields.

TABLE 3

| | Bandwidth of a | Partial bandwidth | Operating |
|---|---|---|---|
| | PPDU carrying | information subfield | channel |
| Feedback | an EHT NDP | values in binary format | width of the |
| RU or | announcement | (B0 B1 B2 B3 B4 | EHT beamformee |
| MRU size | frame (MHz) | B5 B6 B7 B8) | (MHz) |
| 242 | 20 | 010000000 | 20, 40, 80, 160, |
| | 40 | 010000000, 001000000 | 320 |
| | 80 | 010000000, 001000000, | 20, 80, 160, 320 |
| | | 000100000, 000010000 | |
| | 160 | 010000000, 001000000, | |
| | | 000100000, 000010000, | |
| | | 000001000, 000000100, | |
| | | 000000010, 000000001 | |
| 484 | 40 | 011000000 | 40, 80, 160, 320 |
| | 80 | 011000000, 000110000 | 80, 160, 320 |
| | 160 | 010000000, 000110000, | |
| | | 000001100, 000000011 | |
| | 320 | 110000000, 101000000, | |
| | | 100100000, 100010000, | |
| | | 100001000, 100000100, | |
| | | 100000010, 100000001 | |
| 484 + 242 | 80 | 011100000, 011010000, | |
| | | 010110000, 001110000 | |
| | 160 | 011100000, 011010000, | |
| | | 010110000, 001110000 | |
| | | 000001110, 000001101, | |
| | | 000001011, 000000111 | |
| 996 | 80 | 011110000 | |
| | 160 | 011110000, 000001111 | |
| | 320 | 111000000, 100110000, | |
| | | 100001100, 100000011 | |
| 996 + 484 | 160 | 011111100, 011110011, | 160, 320 |
| | | 011001111, 000111111 | |
| | 320 | 111100000, 111010000, | |
| | | 110110000, 101101000, | |
| | | 100001110, 100001101, | |
| | | 100001011, 100001111 | |
| 996 + | 160 | 011101111, 011011111, | |
| 484 + 242 | | 010111111, 001111111, | |
| | | 011111110, 011111101, | |
| | | 011111011, 011110111 | |
| 2 × 996 | 160 | 011111111 | |
| | 320 | 111110000, 100001111 | |
| 2 × | 320 | 111111000, 111110100, | 320 |
| 996 + 484 | | 111101100, 111011100, | |
| | | 110111100, 101111100, | |
| | | 100111110, 100111101, | |
| | | 100111011, 100110111, | |
| | | 100101111, 100011111 | |
| 3 × 996 | 320 | 111111100, 111110011, | |
| | | 111001111, 100111111 | |
| 3 × | 320 | 111111110, 111111101, | |
| 996 + 484 | | 111111011, 111110111, | |
| | | 111101111, 111011111, | |
| | | 110111111, 101111111 | |
| 4 × 996 | 320 | 111111111 | |

It may be learned from Table 3 that a minimum feedback RU of EHT sounding is a 242-tone (242-tone) RU.

The feedback type and Ng field and the codebook size field may jointly indicate a feedback type, subcarrier grouping (denoted as Ng), and a quantization bit number (quantization resolution). Table 4-1 shows code examples of feedback type and Ng fields and codebook size fields in EHT trigger-based sounding sequences. Table 4-2 shows code examples of feedback type and Ng fields and codebook size fields in EHT non-trigger-based sounding sequences.

TABLE 4-1

| Feedback type and Ng | | Codebook size | |
|---|---|---|---|
| B25 | B26 | B28 | Description |
| 0 | 0 | 0 | SU, Ng = 4, quantization |
| | | | resolution (ϕ, Ψ) = {4, 2} |
| 0 | 0 | 1 | SU, Ng = 4, quantization |
| | | | resolution (ϕ, Ψ) = {6, 4} |
| 0 | 1 | 0 | SU, Ng = 16, quantization |
| | | | resolution (ϕ, Ψ) = {4, 2} |
| 0 | 1 | 1 | SU, Ng = 16, quantization |
| | | | resolution (ϕ, Ψ) = {6, 4} |
| 1 | 0 | 0 | MU, Ng = 4, quantization |
| | | | resolution (ϕ, Ψ) = {7, 5} |
| 1 | 0 | 1 | MU, Ng = 4, quantization |
| | | | resolution (ϕ, Ψ) = {9, 7} |
| 1 | 1 | 0 | CQI |
| 1 | 1 | 1 | MU, Ng = 16, quantization |
| | | | resolution (ϕ, Ψ) = {9, 7} |

TABLE 4-2

| | |
|---|---|
| Feedback type and Ng | Codebook size |

| B25 | B26 | B28 | Description |
|---|---|---|---|
| 0 | Reserved | Reserved | SU |
| 1 | 1 | 0 | CQI |

It should be noted that Table 4-1 shows only an example of a correspondence between codes and quantization bit numbers of two types of fields (feedback type and Ng fields, and codebook size fields). Some of the fields in Table 4-1 and their corresponding descriptions may be implemented separately, or some of the fields in Table 4-1 may correspond to other descriptions. In other words, the content in Table 4-1 may be partially used, or Table 4-1 may further include other content. For example, the correspondence between the feedback type and Ng field and a quantization bit number and the correspondence between the codebook size field and the quantization bit number may include one or more rows in Table 4-1. For another example, the “Description” column in Table 4-1 may include only one or two of a feedback type (SU/MU), Ng, or a quantization bit number. For still another example, the “Description” column in Table 4-1 may further include other information.

It should be noted that as described above, in EHT non-trigger-based sounding, a station information field in an EHT NDPA frame is used to request SU feedback. In this case, Ng, a codebook size, and a column number (denoted as Nc) that are used to generate SU feedback may be determined by the EHT beamformee. That is, the NDPA frame is unnecessary to indicate these pieces of information. Therefore, in Table 4-2, the “Description” column does not include parameters such as Ng.

The following describes usage of subcarrier grouping Ng.

When the beamformer requests sounding feedback that is based on an RU, a subcarrier index fed back by the beamformee may be determined based on Ng. In other words, for the RU, some subcarrier indexes of the RU may be fed back; and a specific subcarrier index/subcarrier indexes that is/are fed back may be determined by Ng. Table 5 shows examples of Ng for 242-tone RUs.

TABLE 5
242-tone

| RU index | 20 MHz | | 40 MHz | 80 MHz | 160 MHz |
|---|---|---|---|---|---|
| 1 | Ng = 4 | [−122, −120:4:−4, | [−244:Ng:−4] | [−500:Ng:−260] | [−1012:Ng:−772] |
| | | −2, 2, 4:4:120, | | | |
| | | 122] | | | |
| | Ng = 16 | [−122, −116:16:−4, | | | |
| | | −2, 2, | | | |
| | | 4:16:116, 122] | | | |
| 2 | | | [4:Ng:244] | [−252:Ng:−12] | [−764:Ng:−524] |
| 3 | | | | [12:Ng:252] | [−500:Ng:−260] |
| 4 | | | | [260:Ng:500] | [−252:Ng:−12] |
| 5 | | | | | [12:Ng:252] |
| 6 | | | | | [260:Ng:500] |
| 7 | | | | | [524:Ng:764] |
| 8 | | | | | [772:Ng:1012] |

One of the items in Table 5 is used as an example. When the beamformer transmits a 40 MHz NDP, to request the beamformee to feed back 242-tone RU 1, a subcarrier index fed back by the beamformee may be [−244:Ng:−4].

It should be noted that [x:Ng:y] denotes an arithmetic progression from x to y with an increment of Ng. In other words, [x:Ng:y] denotes x+Ng, x+2Ng, . . . , y. It may be learned that a subcarrier index for feedback being [x:Ng:y] may indicate that the feedback is performed every Ng subcarriers.

If a feedback type is SU or MU feedback, an Nc index field indicates that 1 is subtracted from a quantity of columns of a compressed beamforming feedback matrix, that is, the Nc index field is Nc-1. If a feedback type is CQI, an Nc index field indicates that 1 is subtracted from a quantity of spatial streams in a CQI report, that is, the Nc index field is Nc−1. If the Nc index field is greater than 7, a value of the field is Reserved.

A disambiguation field is set to 1.

### Distributed RU

With the development of technologies, limits on power spectral densities (PSD) are increasingly stringent. For example, in the 6 GHz frequency band, for a non-AP STA in a low power indoor frequency band, a PSD limit is −1 dBm/MHz.

A regular RU (rRU) has consecutive subcarriers. A transmit power of each subcarrier of the rRU is relatively low. This is because a PSD limit is defined on a per MHz and per STA basis, but the subcarriers in the rRU are consecutive. Therefore, a quantity of subcarriers in each MHz is relatively great; and based on the PSD limit, a transmit power of each subcarrier is relatively low.

A dRU has inconsecutive subcarriers. For a dRU, a quantity of subcarriers in each MHz is relatively small, or even there is only one subcarrier in each MHz. Therefore, compared with subcarriers in an rRU, subcarriers in a dRU may be transmitted at a higher power. For example, for a 52-tone dRU distributed over 80 MHz, there may be only one subcarrier per MHz. However, for a 52-tone rRU, there are about 13 subcarriers per MHz. In a 6 GHz low power indoor frequency band, a PSD limit is −1 dBm/MHz. Therefore, for a 52-tone RU (about 4 MHz), a maximum transmit power allowed when an rRU is used is only about 6 dBm; and the transmit power may be increased by 11 dB when a dRU is used. Due to the significant increase of the transmit power, a higher MCS may be implemented, or a longer transmission distance may be reached.

As shown in FIG. 5, all of an STA 1, an STA 2, and an STA 3 may increase their transmit powers by using dRUs. Compared with a case in which an rRU of the same size is used, in this case, each subcarrier obtains a higher transmit power by using dRUs. Therefore, overall spectral efficiency is improved significantly.

It should be noted that an MRU may also have inconsecutive subcarriers and a dMRU. The dRU-related technical solution provided in this application may also be applied to a dMRU. For ease of description, the following merely uses a dRU as an example for description. If it is necessary to apply embodiments described below to a dMRU, “dRU” is replaced with “dMRU”.

A dRU is generally used for uplink (uplink, UL) orthogonal frequency division multiple access (OFDMA) extended-distance transmission, each STA occupies only some of subcarriers, resulting in a low data rate. For example, a 242-tone dRU distributed over 40 MHz occupies 40 MHz of bandwidth, but actually, only 242 subcarriers among a total of 484 subcarriers are used. Therefore, in the dRU mode, the transmission rate is relatively low.

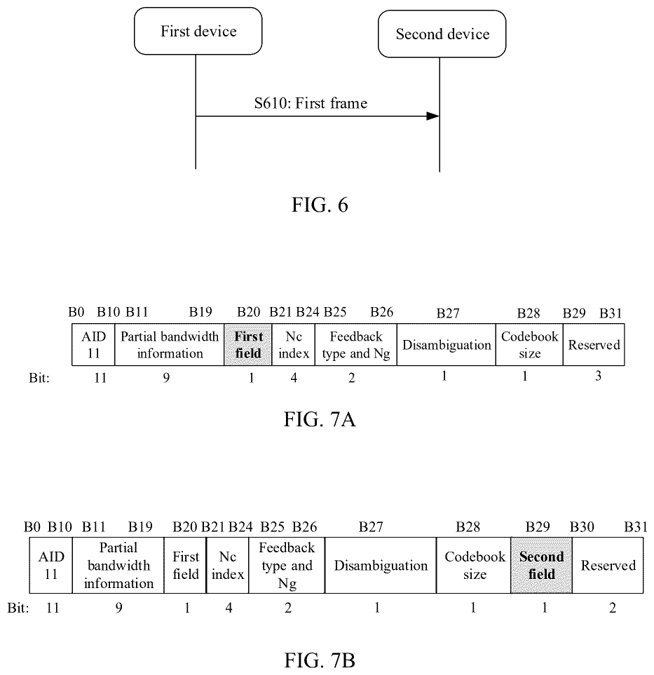

FIG. 6 is a schematic flowchart of a wireless communication method according to an embodiment of this application, to resolve the foregoing problem. The method shown in FIG. 6 may be executed by a first device and a second device. Both the first device and the second device may be communications devices. For example, both the first device and the second device may be UHR stations.

The method shown in FIG. 6 may include step S610.

In step S610, the first device transmits a first frame to the second device.

The first frame may be used to initiate dRU-based sounding feedback (also referred to as channel state feedback). In other words, based on the first frame, the first device may initiate the dRU-based sounding feedback, and the second device may perform the dRU-based sounding feedback. It may be learned that the first device may include a beamformer, and that the second device may include a beamformee.

According to this application, a sounding procedure for a dRU may be implemented based on the first frame. As described above, the sounding procedure is a necessary part in MIMO. Therefore, based on this application, the communications device may further use a plurality of MIMO spatial streams on a dRU for transmission, thereby increasing a data transmission rate.

It should be noted that step S610 may belong to a trigger-based sounding procedure, or may belong to a non-trigger-based sounding procedure. In addition, the sounding procedure to which step S610 belongs may be for SU or may be for MU.

In some embodiments, the first frame may be an NDPA frame. As described above, the NDPA frame may initiate sounding feedback. Therefore, based on this application, the NDPA frame may be used not only to initiate the sounding feedback, but also to indicate that the initiated sounding feedback is based on a dRU.

In some embodiments, the first frame may include a first field.

The first field may be used to indicate whether the sounding feedback is implemented based on a dRU. For example, a value of the first field being 0 may indicate that the sounding feedback is implemented based on a dRU; or the value of the first field being 1 may indicate that the sounding feedback is implemented based on a dRU.

In other words, the first field may be used to indicate whether channel state feedback is implemented based on a dRU. For example, the value of the first field being 0 may indicate that the channel state feedback is implemented based on a dRU; or the value of the first field being 1 may indicate that the channel state feedback is implemented based on a dRU.

In other words, the first field may indicate a type of a sounding feedback RU (feedback RU for short). The type of the feedback RU may include dRU and rRU. Therefore, in some embodiments, the first field may also be referred to as a feedback RU type field. For example, the value of the first field being 0 may indicate that the type of the feedback RU is rRU; and the value of the first field being 1 may indicate that the type of the feedback RU is dRU. Alternatively, the value of the first field being 1 may indicate that the type of the feedback RU is rRU; and the value of the first field being 0 may indicate that the type of the feedback RU is dRU.

In other words, the first field may be used to indicate whether a subcarrier plan (tone plan) used in the sounding feedback is a dRU-based subcarrier plan. For example, the value of the first field being 0 may indicate that the subcarrier plan used in the sounding feedback is the dRU-based subcarrier plan; and the value of the first field being 1 may indicate that the subcarrier plan used in the sounding feedback is an rRU-based subcarrier plan. Alternatively, the value of the first field being 1 may indicate that the subcarrier plan used in the sounding feedback is the dRU-based subcarrier plan; and the value of the first field being 0 may indicate that the subcarrier plan used in the sounding feedback is the rRU-based subcarrier plan.

As described above, a partial bandwidth information field included in the NDPA frame indicates a size of a feedback RU or MRU. Based on this, in a case that the first frame includes the NDPA frame, the first field may indicate whether the RU indicated by the partial bandwidth information field is a dRU; or the first field may indicate whether the MRU indicated by the partial bandwidth information field is a dMRU. For example, the value of the first field being 1 may indicate that the RU indicated by the partial bandwidth information field is the dRU and/or that the MRU indicated by the partial bandwidth information field is the dMRU. Alternatively, the value of the first field being 0 may indicate that the RU indicated by the partial bandwidth information field is the dRU and/or that the MRU indicated by the partial bandwidth information field is the dMRU.

It should be noted that the first field being one bit is used as an example in the foregoing description. The first field may also indicate corresponding information in another manner (for example, by using a plurality of bits), which is not limited in this application.

In some embodiments, the first field may occupy a position of a reserved field in the first frame.

In some embodiments, the first field may be included in a first station information field in the first frame. The first station information field may be one station information field. FIG. 7A is a schematic diagram of a format of a station information field according to an embodiment of this application.

The station information field in FIG. 7A may be a station information field in an NDPA frame. The station information field may include the first field and may further include one or more of the following fields: AID 11, partial bandwidth information, Nc index, feedback type and Ng, disambiguation, codebook size, or reserved. As shown in FIG. 7A, the first field may be located at a reserved bit B20 of the station information field. Alternatively, the first field may be located at one or more of reserved bits B29 to B31 of the station information field.

The first station information field may be used to carry common information. The common information may be information to be decoded and obtained by all receiving stations, that is, the common information is not information to be decoded by only some of the stations.

It may be learned that according to the first station information field, the first frame may indicate the common information by using one station information field. Therefore, even if there is no suitable reserved bit in the first frame to carry the first field (and/or a second field in the following description), the first field (and/or the second field in the following description) may also be carried in this special station information field (namely, the first station information field).

It should be noted that for the first station information field being a station information field capable of carrying the common information, the first station information field may also be referred to as a special station information (special STA info) field. If a station information field is dedicated to a specific station and is to be decoded and obtained by the station but may not be decoded by other stations, the station information field is referred to as a general station information field in this application.

A trigger-based sounding sequence is used as an example. In a case that the first frame is the NDPA frame, the NDPA frame may include N (N is greater than or equal to 2) station information fields. Actually, the N station information fields may include one first station information field and N−1 general station information fields. In other words, although the NDPA frame includes N station information fields, the NDPA frame is actually only used to trigger sounding feedback of N−1 stations.

A non-trigger-based sounding sequence is used as an example. In a case that the first frame is the NDPA frame, the NDPA frame may include two station information fields. Actually, the two station information fields may include one first station information field and one general station information field. In other words, although the NDPA frame includes two station information fields, the NDPA frame is actually used to trigger only SU sounding feedback.

A method for distinguishing the first station information field from a general station information field is not limited in this application. In some embodiments, in a case that the AID 11 field of the station information field is a first value, the station information field may be the first station information field. The first value may be a value of an AID that is not used to indicate a valid station in the related technology. For example, the first value may be greater than or equal to 2007 and less than or equal to 2047. For example, the first value may be equal to 2008.

In some embodiments, the first station information field may immediately follow a field that indicates the common information; or a 1^{st} station information field in a station information field list may be the first station information field. For example, the first station information field may immediately follow a sounding dialog token field. In this case, all receivers may continuously decode the common information, and then each of the receivers targetedly decode the general station information field for a respective station.

It should be noted that, in some embodiments, the general station information field may include the first field. The first field may be used to indicate a feedback RU type of a station indicated by an AID 11 field of the general station information field.

In some embodiments, the first frame may include a second field. The second field may be used to indicate subcarrier grouping of dRU-based sounding feedback, namely, dRU-based Ng.

By grouping subcarriers of the dRU-based sounding feedback, it is unnecessary to feed back every subcarrier in the dRU, such that overheads of the dRU-based sounding feedback may be reduced to some extent.

Optionally, the second field may be included in the first station information field in the first frame. Description of the first station information field is as above and is not be repeated herein.

FIG. 7B is a schematic diagram of a format of another station information field according to an embodiment of this application. The station information field in FIG. 7B is a station information field in an NDPA frame. As shown in FIG. 7B, the station information field may include a second field. The station information field may further include one or more of the following fields: AID 11, partial bandwidth information, Nc index, feedback type and Ng, first field, disambiguation, codebook size, or reserved. The second field may be located at one or more of reserved bits B29 to B31 of the station information field. Alternatively, the second field may be located at a reserved bit B20 of the station information field.

It should be noted that the general station information field may include the second field. The second field may be used to indicate subcarrier grouping of dRU-based sounding feedback of a station indicated by an AID 11 field of the general station information field.

In some embodiments, the second field itself may indicate the subcarrier grouping of the dRU-based sounding feedback.

Optionally, the second field may be used not only to indicate the subcarrier grouping of the dRU-based sounding feedback, but also to indicate subcarrier grouping of rRU-based sounding feedback. For example, a field indicating subcarrier grouping of sounding feedback in the related technology may be reused to indicate the subcarrier grouping of the dRU-based sounding feedback, thereby reducing changes to a standard. For example, the second field may include a feedback type and Ng field, and/or a codebook size field.

For example, whether the first field indicates that a feedback RU type is rRU or dRU, the subcarrier grouping of the sounding feedback may be indicated by the second field. For example, whether the feedback RU type is rRU or dRU, the second field may indicate that Ng is 4 or 16. For example, in a case that the first field indicates the feedback RU type being rRU, the second field may indicate that Ng is 4 or 16. In a case that the first field indicates the feedback RU type being dRU, the second field may indicate that Ng is another candidate value, for example, 2 or 4.

In some embodiments, the second field and another field may jointly indicate the subcarrier grouping of the dRU-based sounding feedback, so that a quantity of bits of the newly added second field can be reduced, thereby occupying fewer communications resources. For example, the second field may occupy one bit.

Optionally, the foregoing another field may include, for example, a third field. The third field may be, for example, an existing field in the related technology. The third field may be used to indicate the subcarrier grouping of the rRU-based sounding feedback. The third field may include one or more fields. For example, the third field may include a feedback type and Ng field, and/or a codebook size field.

For example, in a case that the first field indicates the feedback RU type being rRU, the subcarrier grouping of the rRU-based sounding feedback may be indicated by the third field. In this case, the second field may be reserved. In a case that the first field indicates the feedback RU type being dRU, the subcarrier grouping of the dRU-based sounding feedback may be jointly indicated by the second field and the third field. For this example, the subcarrier grouping of the sounding feedback may also be jointly indicated by the first field, the second field, and the third field.

In a case that the third field includes the feedback type and Ng field, and that the second field and the third field jointly indicate the subcarrier grouping of the dRU-based sounding feedback, the second field may be considered as a supplement or extension of the feedback type and Ng field. Therefore, the second field may also be referred to as a feedback type and subcarrier grouping extension (feedback type and Ng extension) field.

In some embodiments, a dRU of the sounding feedback may be a first dRU. A subcarrier plan of the first dRU may be that: the first dRU may include m second dRUs and n tones (tone), where a size of the second dRU may be less than that of the first dRU; m is an integer greater than 0; and n is an integer greater than or equal to 0.

For ease of understanding, the following describes the subcarrier plan of the dRU.

In some embodiments, the subcarrier plan of the dRU may be configured as follows: a 26-tone (26-tone) rRU is used as a reference RU, and subcarriers are mapped over 20 MHz, 40 MHz, 80 MHz, 160 MHz, and 320 MHz in a distributed manner to form a 26-tone dRU. For example, in bandwidth of 20 MHz, a subcarrier index of a 26-tone rRU 1 is [−121:−96]. After distributed mapping, a subcarrier index of a 26-tone dRU 1 may be [−121, −112, −103, −94, −85, −76, −66, −57, −48, −39, −30, −21, −12, 4, 13, 22, 31, 40, 49, 58, 67, 77, 86, 95, 104, 113], where [x1:y1] denotes a set of subcarriers whose indexes k meet x1 ≤k ≤y1; and [x1:y1, x2:y2] denotes a set of subcarriers whose indexes k meet x1<k≤y1 or x2≤k≤y2.

In some embodiments, dRUs of some sizes (for example, the first dRU) may each be formed by a reference RU (namely, the second dRU) and an additional subcarrier (namely, a tone). For example, a reference dRU may be a 26-tone dRU. In a case that the first dRU is a 242-tone dRU, the 242-tone dRU may be formed by nine 26-tone dRUs and eight tones. In a case that the first dRU is a 484-tone dRU, the 484-tone dRU may be formed by 18 26-tone dRUs and 16 tones. In a case that the first dRU is a 996-tone dRU, the 996-tone dRU may be formed by 37 26-tone dRUs and 34 tones. In a case that the first dRU is a 2*996-tone dRU, the 2*996-tone dRU may be formed by 74 26-tone dRUs and 68 tones.

In some embodiments, the second field may be used to indicate subcarrier grouping of m second dRUs and n tones. In other words, the n additional tones may participate in the grouping. For example, subcarriers in the m second dRUs and the n tones may be sorted based on indexes (index) of the subcarriers, and then grouped based on the subcarrier grouping indicated by the second field. The sorting may be performed in ascending order. The sounding feedback may provide grouped subcarrier indexes.

A solution in which the n additional tones participate in the grouping may be applied to a case in which subcarrier distribution of the first dRU is approximately uniform, namely, a case in which the n additional tones are approximately uniformly distributed over dRU-containing bandwidth (also referred to as dRU distribution bandwidth). In this case, the n additional tones participate in grouping; and sounding performance after subcarrier grouping in a dRU may almost match that after subcarrier grouping in an rRU.

In some embodiments, the second field is used to indicate subcarrier grouping of the m second dRUs. In other words, the n additional tones may not participate in the grouping. For example, subcarriers in the m second dRUs may be sorted based on indexes of the subcarriers, and then grouped based on the subcarrier grouping indicated by the second field. The sorting may be performed in ascending order. The sounding feedback may provide grouped subcarrier indexes and subcarrier indexes of the n tones.

A solution in which the n additional tones do not participate in the grouping may be applied to a case in which subcarrier distribution of the first dRU is non-uniform, namely, a case in which the n additional tones are non-uniformly distributed over dRU-containing bandwidth (also referred to as dRU distribution bandwidth). In this case, the n additional tones do not participate in grouping, such that sounding performance after subcarrier grouping in a dRU may match that after subcarrier grouping in an rRU.

In some embodiments, a candidate value for the subcarrier grouping of the dRU-based sounding feedback may be the same as a candidate value for subcarrier grouping of rRU-based sounding feedback. For example, in Table 4-1, candidate values for subcarrier grouping of rRU-based sounding feedback are 4 and 16; and candidate values for subcarrier grouping of dRU-based sounding feedback may also be 4 and 16. In other words, the subcarrier grouping of the dRU-based sounding feedback indicated by the second field may be 4 or 16.

Based on the technical solution in which a candidate value for the subcarrier grouping of the dRU-based sounding feedback is the same as a candidate value for subcarrier grouping of rRU-based sounding feedback, an indication process of the subcarrier grouping of the dRU-based sounding feedback can be implemented based on a related technology. Therefore, implementation complexity is low; changes to the related technology are relatively small; and feasibility is relatively high. In addition, it should be noted that the solution may be applied to a case in which there are consecutive subcarriers in a dRU subcarrier plan.

For example, in a case that a candidate value for the subcarrier grouping of the dRU-based sounding feedback may be the same as a candidate value for subcarrier grouping of rRU-based sounding feedback, the subcarrier grouping of the dRU-based sounding feedback can be indicated by using only a feedback type and Ng field and a codebook size field in the related technology. For example, dRU-based Ng may be indicated according to the coding scheme in Table 4-1 and/or Table 4-2.

In some embodiments, a candidate value for the subcarrier grouping of the dRU-based sounding feedback may not be exactly the same as a candidate value for subcarrier grouping of rRU-based sounding feedback. For example, in Table 4-1, candidate values for subcarrier grouping of rRU-based sounding feedback are 4 and 16; and candidate values for subcarrier grouping of dRU-based sounding feedback may include other values different from 4 and 16, or may include 4 and/or 16. For example, a value of the subcarrier grouping of the dRU-based sounding feedback includes: 1, 2, 4, or 8.

In some embodiments, a minimum value of the candidate value for the subcarrier grouping of the dRU-based sounding feedback may be less than a minimum value of the candidate value for the subcarrier grouping of the rRU-based sounding feedback. Subcarriers contained in an rRU are all consecutive, but subcarriers contained in a dRU are distributed, namely, spaced apart. Therefore, when a value of Ng is relatively small, sounding performance after subcarrier grouping in the dRU may almost match that after subcarrier grouping in the rRU.

In some embodiments, a quantity of candidate values for the subcarrier grouping of the dRU-based sounding feedback may be greater than a quantity of candidate values for subcarrier grouping of the rRU-based sounding feedback. Table 4-1 is used as an example. A quantity of candidate values for subcarrier grouping of rRU-based sounding feedback is 2 (that is, the candidate values are 4 and 16); and a quantity of candidate values for subcarrier grouping of dRU-based sounding feedback is 4 (for example, the candidate values are 1, 2, 4, and 8).

It may be understood that a greater quantity of candidate values leads to more flexible subcarrier grouping and better adaptation to a subcarrier plan of the dRU. For example, in a case that subcarriers in the dRU are distributed relatively uniformly, the subcarrier grouping may include more subcarriers; and in a case that the subcarriers in the dRU are distributed non-uniformly, the subcarrier grouping may include less subcarriers.

If a quantity of candidate values for subcarrier grouping of sounding feedback to be indicated is relatively great, dRU-based subcarrier grouping may be jointly indicated by the first field, the second field, and the third field.

For example, the first field may be a feedback RU type field; the second field may include a feedback type and Ng extension field; and the third field may include a feedback type and Ng field, and a codebook size field. These fields may be jointly encoded to indicate a feedback type, Ng, quantization resolution, and an RU type. Table 6-1 and Table 6-2 are example diagrams of joint coding of trigger-feedback-based sounding and non-trigger-based sounding.

TABLE 6-1
Trigger-feedback-based sounding

| | Feedback | | Feedback | | |
|---|---|---|---|---|---|
| Feedback | type and | | type and Ng | Codebook | |
| RU type | Ng | | extension | size | Description |
| 0 | 0 | 0 | Reserved | 0 | SU, Ng = 4, quantization |
| | | | | | resolution (ϕ, Ψ) = {4, 2}, rRU |
| | 0 | 0 | | 1 | SU, Ng = 4, quantization |
| | | | | | resolution (ϕ, Ψ) = {6, 4}, rRU |
| | 0 | 1 | | 0 | SU, Ng = 16, quantization |
| | | | | | resolution (ϕ, Ψ) = {4, 2}, rRU |
| | 0 | 1 | | 1 | SU, Ng = 16, quantization |
| | | | | | resolution (ϕ, Ψ) = {6, 4}, rRU |
| | 1 | 0 | | 0 | MU, Ng = 4, quantization |
| | | | | | resolution (ϕ, Ψ) = {7, 5}, rRU |
| | 1 | 0 | | 1 | MU, Ng = 4, quantization |
| | | | | | resolution (ϕ, Ψ) = {9, 7}, rRU |
| | 1 | 1 | | 0 | CQI, rRU |
| | 1 | 1 | | 1 | MU, Ng = 16, quantization |
| | | | | | resolution (ϕ, Ψ) = {9, 7}, rRU |
| 1 | 0 | 0 | 0 | 0 | SU, Ng = 1, quantization |
| | | | | | resolution (ϕ, Ψ) = {4, 2}, dRU |
| | 0 | 0 | 0 | 1 | SU, Ng = 1, quantization |
| | | | | | resolution (ϕ, Ψ) = {6, 4}, dRU |
| | 0 | 0 | 1 | 0 | SU, Ng = 2, quantization |
| | | | | | resolution (ϕ, Ψ) = {4, 2}, dRU |
| | 0 | 0 | 1 | 1 | SU, Ng = 2, quantization |
| | | | | | resolution (ϕ, Ψ) = {6, 4}, dRU |
| | 0 | 1 | 0 | 0 | SU, Ng = 4, quantization |
| | | | | | resolution (ϕ, Ψ) = {4, 2}, dRU |
| | 0 | 1 | 0 | 1 | SU, Ng = 4, quantization |
| | | | | | resolution (ϕ, Ψ) = {6, 4}, dRU |
| | 0 | 1 | 1 | 0 | SU, Ng = 8, quantization |
| | | | | | resolution (ϕ, Ψ) = {4, 2}, dRU |
| | 0 | 1 | 1 | 1 | SU, Ng = 8, quantization |
| | | | | | resolution (ϕ, Ψ) = {6, 4}, dRU |
| | 1 | 0 | 0 | 0 | MU, Ng = 1, quantization |
| | | | | | resolution (ϕ, Ψ) = {7, 5}, dRU |
| | 1 | 0 | 0 | 1 | MU, Ng = 1, quantization |
| | | | | | resolution (ϕ, Ψ) = {9, 7}, dRU |
| | 1 | 0 | 1 | 0 | MU, Ng = 2, quantization |
| | | | | | resolution (ϕ, Ψ) = {7, 5}, dRU |
| | 1 | 0 | 1 | 1 | MU, Ng = 2, quantization |
| | | | | | resolution (ϕ, Ψ) = {9, 7}, dRU |
| | 1 | 1 | 0 | 0 | MU, Ng = 4, quantization |
| | | | | | resolution (ϕ, Ψ) = {7, 5}, dRU |
| | 1 | 1 | 0 | 1 | MU, Ng = 4, quantization |
| | | | | | resolution (ϕ, Ψ) = {9, 7}, dRU |
| | 1 | 1 | 1 | 0 | CQI, dRU |
| | 1 | 1 | 1 | 1 | MU, Ng = 8, quantization |
| | | | | | resolution (ϕ, Ψ) = {9, 7}, dRU |

TABLE 6-2
Trigger-feedback-based sounding

| | | | Feedback | | |
|---|---|---|---|---|---|
| Feedback | Feedback type | | type and Ng | Codebook | |
| RU type | and Ng | | extension | size | Description |
| 0 | 0 | Reserved | Reserved | Reserved | SU, rRU |
| | 1 | 1 | | 0 | CQI, rRU |
| 1 | 0 | Reserved | | Reserved | SU, dRU |
| | 1 | 1 | | 0 | CQI, dRU |

It should be noted that Table 6-1 shows only examples of a correspondence between codes and quantization bit numbers of four types of fields (feedback RU type fields, feedback type and Ng fields, codebook size fields, and feedback type and Ng extension fields). Some of the fields in Table 6-1 and their corresponding descriptions may be implemented separately, or some of the fields in Table 6-1 may correspond to other descriptions. In other words, the content in Table 6-1 may be partially used, or Table 6-1 may further include other content. For example, the correspondence between the four fields and a quantization bit number may include one or more rows in Table 6-1. For another example, the “Description” column in Table 6-1 may include only one or two of a feedback type (SU/MU), Ng, or a quantization bit number. For still another example, the “Description” column in Table 6-1 may further include other information.

As described above, the first frame may be an NDPA frame. This application proposes that the first frame may be an NDPA frame of a first type. The following describes the NDPA frame of the first type.

In some embodiments, the NDPA frame of the first type may be used to indicate a UHR-related technology. Therefore, the first type may also be referred to as a UHR NDPA frame type; and the NDPA frame of the first type may also be referred to as a UHR NDPA frame.

The NDPA frame may include a fourth field. The fourth field may be used to indicate whether the NDPA frame is of the first type. Alternatively, in other words, the fourth field may be used to indicate a type or variant of the NDPA frame. The type or variant of the NDPA frame includes the first type.

For example, the fourth field may include a first station information field. Description of the first station information field may be as above. In other words, the first station information field may be a special station information field.

For example, in a case that the NDPA frame includes the first station information field, the NDPA frame may be an NDPA frame of the first type. In a case that the NDPA frame does not include the first station information field, the NDPA frame may be an NDPA frame of another type. The NDPA frame of the another type may be a variant (for example, a variant shown in FIG. 2) indicated by an NDPA variant field of a sounding dialog token field in the NDPA frame described above.

For another example, the first station information field may be combined with another field in the NDPA frame, to indicate whether the NDPA frame is an NDPA frame of the first type. For example, the NDPA frame may include a sounding dialog token field. In a case that the NDPA frame includes the first station information field and that an NDPA variant field of the sounding dialog token field in the NDPA frame is set to 3, the NDPA frame may be an NDPA frame of the first type. In a case that the NDPA frame does not include the first station information field or that an NDPA variant field of the sounding dialog token field in the NDPA frame is not set to 3, the NDPA frame may be an NDPA frame of another type. The NDPA frame of the another type may be indicated by the NDPA variant field in the NDPA frame described above.

For example, if the NDPA variant field of the sounding dialog token field in the NDPA frame is set to 3, and the first station information field appears (for example, there is station information whose AID 11 is equal to a specific value (for example: 2008)), it may be indicated that the NDPA frame may be an NDPA frame of the first type.

In summary, the first station information field may indicate one or more types of information. For example, the first station information field may indicate one or more of the following information: whether the NDPA frame being an NDPA frame of the first type, whether the sounding feedback is implemented based on a dRU, or the subcarrier grouping of the dRU-based sounding feedback. The first station information field may also be used to indicate other common information. Information indicated by the first station information field is not limited in this application.

In some embodiments, the NDPA frame may further include a sounding dialog token field. The fourth field may immediately follow the sounding dialog token field. It may be understood that a type of an NDPA frame indicated by the fourth field may be common information. The fourth field immediately follows the sounding dialog token field, so that a receiver may continue, after the sounding dialog token field, to decode the common information indicated by the fourth field, and then targetedly decode subsequent exclusive user information for the station.

It should be noted that the NDPA frame of the first type is unnecessarily used to initiate the dRU-based sounding feedback, that is, the NDPA frame of the first type may also be used for realizing another function. In other words, use of the NDPA frame of the first type is not limited in this application.

It should be noted that although a minimum RU size is 242-tone in the related-sounding technology (for example, EHT sounding), the size is not limited in this application, that is, embodiments provided in this application can be used regardless of a size of a dRU or a dMRU. In other words, even when a dRU or dMRU is less than 242-tone (hereinafter referred to as a small-size dRU or dMRU), MIMO multi-spatial stream transmission can be performed. For example, the small-size dRU or dMRU may include: a 26-tone dRU, a 52-tone dRU, a 106-tone dRU, a 52+26-tone dMRU, or a 106+26-tone dMRU.

In some embodiments, in small-size-dRU-based sounding feedback, subcarriers of the sounding feedback may be grouped or may not be grouped. In a case that the subcarriers are not grouped, the subcarriers of the sounding feedback may be all subcarriers included in a dRU.

In some embodiments, in small-size-dRU-based sounding feedback, bandwidth containing the dRU and/or subcarrier grouping in the bandwidth are to be indicated. The indication process may be improved based on a sounding procedure in the related technology (for example, an IEEE 802.11 be EHT sounding procedure) or a technical solution provided in this application. Such an improvement solution is simple to be implemented, but resulting in specific feedback overheads. For example, when performing dRU-based sounding, a beamformer may indicate dRU-containing bandwidth in the NDPA frame, and request a beamformee to feed back the dRU-containing bandwidth and grouped subcarriers.

For ease of understanding of this application, this application is described below by using Embodiment 1.

### Embodiment 1

Embodiment 1 is described by using a trigger-based sounding procedure as an example. In Embodiment 1, there are consecutive subcarriers in a subcarrier plan of a dRU. Compared with an rRU, no Ng is added in Embodiment 1, that is, a method for indicating Ng in the dRU is implemented by using an indication method for an rRU in the related technology.

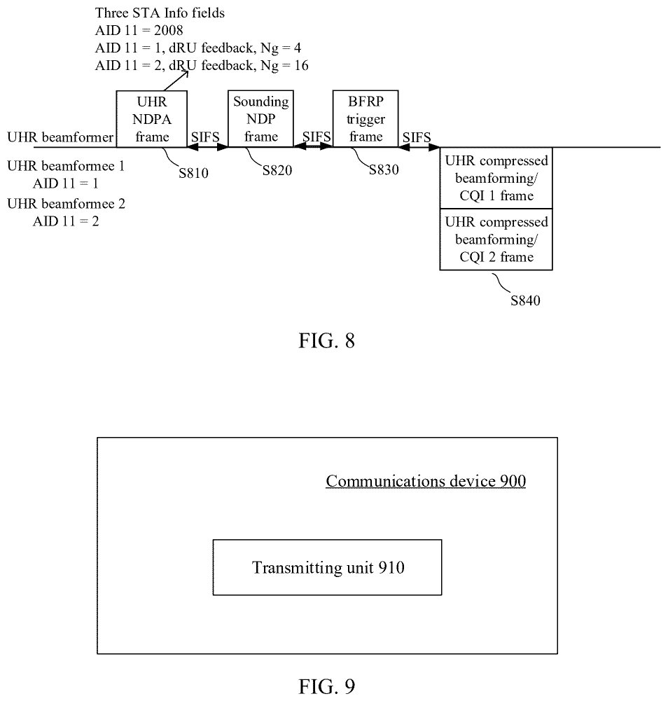

FIG. 8 is a schematic flowchart of a wireless communication method according to Embodiment 1. The method shown in FIG. 8 may be performed by a beamformee 1 (AID 11=1), a beamformee 2 (AID 11=2), and a beamformer. For example, the beamformer may correspond to the first device in this application; and the beamformee 1 or the beamformee 2 may correspond to the second device in this application.

The method shown in FIG. 8 may include step S810 to step S840.

In step S810, the beamformer transmits a 40 MHz UHR NDPA frame.

In the UHR NDPA frame, an NDPA variant field of a sounding dialog token field is set to 3.

There are three station information fields in the UHR NDPA frame.

In a 1^{st} station information field, AID 11=2008, which indicates that a special station information field appears. A value of the station information field is combined with a value of the sounding dialog token field, which may indicate that the NDPA frame is a UHR NDPA frame.

In a 2^{nd} station information field, AID 11=1, that is, the station information is for the beamformee 1. A partial bandwidth information field indicates a 242-tone RU 1 (010000000). 2^{nd} station information further indicates dRU-based sounding feedback, and Ng=4. Ng is indicated by a code in Table 4-1.

In a 3^{rd} station information field, AID 11=2, that is, the station information is for the beamformee 2. A partial bandwidth information field indicates a 242-tone RU 2 (001000000). 3^{rd} station information further indicates dRU-based sounding feedback, and Ng=16. Ng is indicated by a code in Table 4-1.

In step S820, after an SIFS, the beamformer transmits a 40 MHz sounding NDP.

In step S830, the beamformer transmits a BFRP trigger frame in an SIFS after the sounding NDP, to request UHR compressed beamforming feedback (UHR compressed beamforming feedback) from the beamformee 1 and the beamformee 2.

In step S840, the beamformee 1 feeds back a UHR compressed beamforming/CQI 1 frame. The beamformee 2 feeds back a UHR compressed beamforming/CQI 2 frame.

In Embodiment 1, a subcarrier plan of a 242-tone dRU 1 may be as follows:
[−244, −243, −241, −239, −238, −236, −234, −232, −229, −227, −225, −223, −221, −220, −218, −216, −214, −211, −209, −207, −205, −203, −202, −200, −198, −196, −193, −191, −190, −189, −187, −185, −183, −182, −180, −178, −176, −173, −171, −169, −167, −165, −164, −162, −160, −158, −155, −153, −151, −149, −147, −146, −144, −142, −140, −137, −136, −134, −132, −130, −128, −127, −125, −123, −121, −118, −116, −114, −112, −110, −109, −108, −106, −104, −102, −99, −97, −95, −93, −91, −90, −88, −86, −84, −81, −79, −77, −75, −73, −72, −70, −68, −66, −63, −61, −59, −57, −56, −55, −53, −52, −50, −48, −46, −43, −41, −39, −37, −35, −34, −32, −30, −28, −25, −23, −21, −19, −17, −16, −14, −12, −10, −7, −5, −3, 4, 6, 8, 9, 11, 13, 15, 18, 20, 22, 24, 26, 27, 29, 31, 33, 36, 38, 40, 42, 44, 45, 47, 49, 51, 54, 58, 60, 62, 64, 65, 67, 69, 71, 74, 76, 78, 80, 82, 83, 85, 87, 89, 92, 94, 96, 98, 100, 101, 103, 105, 107, 111, 113, 115, 117, 119, 120, 122, 124, 126, 129, 131, 133, 135, 138, 139, 141, 143, 145, 148, 150, 152, 154, 156, 157, 159, 161, 163, 166, 168, 170, 172, 174, 175, 177, 179, 181, 184, 186, 188, 192, 194, 195, 197, 199, 201, 204, 206, 208, 210, 212, 213, 215, 217, 219, 222, 224, 226, 228, 230, 231, 233, 235, 237, 240, 242].

It may be learned that the subcarrier plan of the 242-tone dRU 1 includes subcarriers with consecutive indexes, for example, −244 and −243 are consecutive, −239 and −238 are consecutive, and so on.

For the beamformee 1, Ng=4. Therefore, the beamformee 1 performs feedback every four subcarrier indexes in the 242-tone dRU 1 after all subcarrier indexes in the 242-tone dRU 1 are sorted in ascending order. In other words, subcarrier indexes of the 242-tone dRU 1 that are fed back by the beamformee 1 are those shown in bold in the subcarrier plan, namely, a total of 61 subcarrier indexes: −244, −238, −229, −221, −214, −205, −198, −190, −183, −176, −167, −160, −151, −144, −136, −128, −121, −112, −106, −97, −90, −81, −73, −66, −57, −52, −43, −35, −28, −19, −12, −3, 9, 18, 26, 33, 42, 49, 60, 67, 76, 83, 92, 100, 107, 117, 124, 133, 141, 150, 157, 166, 174, 181, 192, 199, 208, 215, 224, 231, and 240.

A subcarrier plan of a 242-tone dRU 2 is as follows:
[−242, −240, −237, −235, −233, −231, −230, −228, −226, −224, −222, −219, −217, −215, −213, −212, −210, −208, −206, −204, −201, −199, −197, −195, −194, −192, −188, −186, −184, −181, −179, −177, −175, −174, −172, −170, −168, −166, −163, −161, −159, −157, −156, −154, −152, −150, −148, −145, −143, −141, −139, −138, −135, −133, −131, −129, −126, −124, −122, −120, −119, −117, −115, −113, −111, −107, −105, −103, −101, −100, −98, −96, −94, −92, −89, −87, −85, −83, −82, −80, −78, −76, −74, −71, −69, −67, −65, −64, −62, −60, −58, −54, −51, −49, −47, −45, −44, −42, −40, −38, −36, −33, −31, −29, −27, −26, −24, −22, −20, −18, −15, −13, −11, −9, −8, −6, −4, 3, 5, 7, 10, 12, 14, 16, 17, 19, 21, 23, 25, 28, 30, 32, 34, 35, 37, 39, 41, 43, 46, 48, 50, 52, 53, 55, 56, 57, 59, 61, 63, 66, 68, 70, 72, 73, 75, 77, 79, 81, 84, 86, 88, 90, 91, 93, 95, 97, 99, 102, 104, 106, 108, 109, 110, 112, 114, 116, 118, 121, 123, 125, 127, 128, 130, 132, 134, 136, 137, 140, 142, 144, 146, 147, 149, 151, 153, 155, 158, 160, 162, 164, 165, 167, 169, 171, 173, 176, 178, 180, 182, 183, 185, 187, 189, 190, 191, 193, 196, 198, 200, 202, 203, 205, 207, 209, 211, 214, 216, 218, 220, 221, 223, 225, 227, 229, 232, 234, 236, 238, 239, 241, 243, 244].

It may be learned that there are subcarriers with consecutive indexes in the subcarrier plan of the 242-tone dRU 2, for example, −231 and −230 are consecutive, −195 and −194 are consecutive, and so on.

For the beamformee 2, Ng=16. Therefore, the beamformee 2 performs feedback every 16 subcarrier indexes in the 242-tone dRU 2 after all subcarrier indexes in the 242-tone dRU 2 are sorted in ascending order. In other words, subcarrier indexes of the 242-tone dRU 2 that are fed back by the beamformee 2 are those shown in bold in the subcarrier plan of the 242-tone dRU 2, namely, a total of 16 subcarrier indexes: −242, −210, −175, −143, −111, −78, −44, −11, 25, 56, 88, 118, 149, 182, 211, 243.

The foregoing describes the method embodiments of this application in detail. The following describes apparatus embodiments of this application in detail. It should be understood that the description of the method embodiments corresponds to the description of the apparatus embodiments, and therefore, for a part that is not described in detail, reference may be made to the foregoing method embodiments.

FIG. 9 is a schematic structural diagram of a communications device 900 according to an embodiment of this application. The communications device 900 may be a first device. The communications device 900 may include a transmitting unit 910.

The transmitting unit 910 is configured to transmit a first frame to a second device, where the first frame is used to initiate dRU-based sounding feedback.

In some embodiments, the first frame includes a first field; and the first field is used to indicate whether the sounding feedback is implemented based on a dRU.

In some embodiments, the first field is included in a first station information field in the first frame.

In some embodiments, the first frame includes a second field; and the second field is used to indicate subcarrier grouping of the dRU-based sounding feedback.

In some embodiments, the second field is included in a first station information field in the first frame.

In some embodiments, the first frame further includes a third field; the third field is used to indicate subcarrier grouping of rRU-based sounding feedback; and the second field and the third field jointly indicate the subcarrier grouping of the dRU-based sounding feedback.

In some embodiments, in a case that the dRU is a first dRU and the first dRU includes m second dRUs and n tones, the second field is used to indicate subcarrier grouping of the m second dRUs and the n tones, where m is an integer greater than 0, and n is an integer greater than or equal to 0.

In some embodiments, in a case that the dRU is a first dRU and the first dRU includes m second dRUs and n tones, the second field is used to indicate subcarrier grouping of the m second dRUs, where m is an integer greater than 0, and n is an integer greater than or equal to 0.

In some embodiments, a candidate value for the subcarrier grouping of the dRU-based sounding feedback is the same as a candidate value for subcarrier grouping of rRU-based sounding feedback.

In some embodiments, a candidate value for the subcarrier grouping of the dRU-based sounding feedback is not exactly the same as a candidate value for subcarrier grouping of rRU-based sounding feedback.

In some embodiments, a value of the subcarrier grouping of the dRU-based sounding feedback includes: 1, 2, 4, or 8.

In some embodiments, a quantity of candidate values for the subcarrier grouping of the dRU-based sounding feedback is greater than a quantity of candidate values for subcarrier grouping of the rRU-based sounding feedback.

In some embodiments, the first frame is an NDPA frame of a first type; the NDPA frame includes a fourth field; and the fourth field is used to indicate whether the NDPA frame is of the first type.

In some embodiments, the NDPA frame further includes a sounding dialog token field; and the fourth field immediately follows the sounding dialog token field.

In some embodiments, the fourth field includes a first station information field; and the NDPA frame is determined as an NDPA frame of the first type in a case that the NDPA frame includes the first station information field.

In some embodiments, the NDPA frame being determined as the NDPA frame of the first type in the case that the NDPA frame includes the first station information field includes: the NDPA frame being determined as the NDPA frame of the first type in a case that the NDPA frame includes the first station information field and that an NDPA variant field of a sounding dialog token field in the NDPA frame is set to 3.

In some embodiments, in a case that an AID 11 field of a station information field in the NDPA frame is a first value, the station information field is the first station information field.

In some embodiments, the first value is greater than or equal to 2007 and less than or equal to 2047.

In an optional embodiment, the transmitting unit 910 may be the transceiver 1130. The communications device 900 may further include a processor 1110 and a memory 1120, which are specifically shown in FIG. 11.

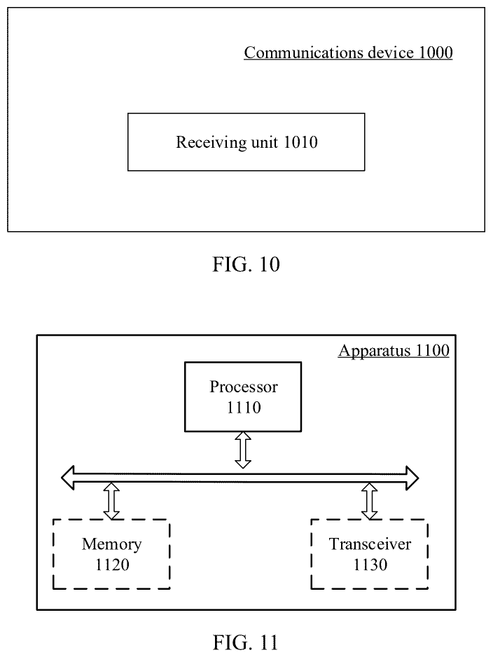

FIG. 10 is a schematic structural diagram of a communications device 1000 according to an embodiment of this application. The communications device 1000 may be a second device. The communications device 1000 includes a receiving unit 1010.

The receiving unit 1010 is configured to receive a first frame transmitted by a first device, where the first frame is used to initiate dRU-based sounding feedback.

In some embodiments, the first frame includes a first field; and the first field is used to indicate whether the sounding feedback is implemented based on a dRU.

In some embodiments, the first field is included in a first station information field in the first frame.

In some embodiments, the first frame includes a second field; and the second field is used to indicate subcarrier grouping of the dRU-based sounding feedback.

In some embodiments, the second field is included in a first station information field in the first frame.

In some embodiments, the first frame further includes a third field; the third field is used to indicate subcarrier grouping of rRU-based sounding feedback; and the second field and the third field jointly indicate the subcarrier grouping of the dRU-based sounding feedback.

In some embodiments, in a case that the dRU is a first dRU and the first dRU includes m second dRUs and n tones, the second field is used to indicate subcarrier grouping of the m second dRUs and the n tones, where m is an integer greater than 0, and n is an integer greater than or equal to 0.

In some embodiments, in a case that the dRU is a first dRU and the first dRU includes m second dRUs and n tones, the second field is used to indicate subcarrier grouping of the m second dRUs, where m is an integer greater than 0, and n is an integer greater than or equal to 0.

In some embodiments, a candidate value for the subcarrier grouping of the dRU-based sounding feedback is the same as a candidate value for subcarrier grouping of rRU-based sounding feedback.

In some embodiments, a candidate value for the subcarrier grouping of the dRU-based sounding feedback is not exactly the same as a candidate value for subcarrier grouping of rRU-based sounding feedback.

In some embodiments, a value of the subcarrier grouping of the dRU-based sounding feedback includes: 1, 2, 4, or 8.

In some embodiments, a quantity of candidate values for the subcarrier grouping of the dRU-based sounding feedback is greater than a quantity of candidate values for subcarrier grouping of the rRU-based sounding feedback.

In some embodiments, the first frame is an NDPA frame of a first type; the NDPA frame includes a fourth field; and the fourth field is used to indicate whether the NDPA frame is of the first type.

In some embodiments, the NDPA frame further includes a sounding dialog token field; and the fourth field immediately follows the sounding dialog token field.

In some embodiments, the fourth field includes a first station information field; and the NDPA frame is an NDPA frame of the first type in a case that the NDPA frame includes the first station information field.

In some embodiments, the NDPA frame being determined as the NDPA frame of the first type in the case that the NDPA frame includes the first station information field includes: the NDPA frame being determined as the NDPA frame of the first type in a case that the NDPA frame includes the first station information field and that an NDPA variant field of a sounding dialog token field in the NDPA frame is set to 3.

In some embodiments, in a case that an AID 11 field of a station information field in the NDPA frame is a first value, the station information field is the first station information field.

In some embodiments, the first value is greater than or equal to 2007 and less than or equal to 2047.

In an optional embodiment, the receiving unit 1010 may be a transceiver 1130. The communications device 1000 may further include a processor 1110 and a memory 1120, which are specifically shown in FIG. 11.

FIG. 11 is a schematic structural diagram of an apparatus for communication according to an embodiment of this application. Dashed lines in FIG. 11 indicate that the units or modules are optional. The apparatus 1100 may be configured to implement the methods described in the foregoing method embodiments. The apparatus 1100 may be a chip or a communications device.

The apparatus 1100 may include one or more processors 1110. The processor 1110 may support the apparatus 1100 in implementing the methods described in the foregoing method embodiments. The processor 1110 may be a general-purpose processor or a dedicated processor. For example, the processor may be a central processing unit (CPU). Alternatively, the processor may be another general-purpose processor, a digital signal processor (DSP), an application specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

The apparatus 1100 may further include one or more memories 1120. The memory 1120 stores a program. The program may be executed by the processor 1110, to cause the processor 1110 to execute the method described in the foregoing method embodiments. The memory 1120 may be separate from the processor 1110 or may be integrated into the processor 1110.

The apparatus 1100 may further include a transceiver 1130. The processor 1110 may communicate with another device or chip by using the transceiver 1130. For example, the processor 1110 may transmit data to and receive data from another device or chip by using the transceiver 1130.

An embodiment of this application further provides a computer-readable storage medium for storing a program. The computer-readable storage medium may be applied to the communications device provided in embodiments of this application; and the program causes a computer to execute the method executed by the communications device in various embodiments of this application.

An embodiment of this application further provides a computer program product. The computer program product includes a program. The computer program product may be applied to the communications device provided in embodiments of this application, and the program causes a computer to execute the method executed by the communications device in various embodiments of this application.

An embodiment of this application further provides a computer program. The computer program may be applied to a communications device provided in embodiments of this application; and the computer program causes a computer to execute the method executed by the communications device in embodiments of this application.

It should be understood that the terms “system” and “network” in this application may be used interchangeably. In addition, the terms used in this application are used only to illustrate specific embodiments of this application, but are not intended to limit this application. The terms “first”, “second”, “third”, “fourth”, and the like in the specification, claims, and accompanying drawings of this application are used to distinguish between different objects, rather than to describe a specific order. In addition, the terms “include” and “have” and any variations thereof are intended to cover a non-exclusive inclusion.

In this embodiment of this application, a “field” may also be referred to as a “domain (field)”, a “subdomain (subfield)”, or a “subfield (subfield)”. One field may occupy one or more bytes (byte/octet), or one field may occupy one or more bits (bit).

In embodiments of this application, “indication” mentioned herein may refer to a direct indication, or may refer to an indirect indication, or may mean that there is an association relationship. For example, A indicates B, which may mean that A directly indicates B, for example, B may be obtained by means of A; or may mean that A indirectly indicates B, for example, A indicates C, and B may be obtained by means of C; or may mean that there is an association relationship between A and B.

In embodiments of this application, “B corresponding to A” means that B is associated with A, and B may be determined based on A. However, it should be further understood that, determining B based on A does not mean determining B based only on A, but instead, B may be determined based on A and/or other information.

In descriptions of embodiments of this application, the term “corresponding” may mean that there is a direct or indirect correspondence between two elements, or that there is an association relationship between two elements, or that there is a relationship of “indicating” and “being indicated”, “configuring” and “being configured”, or the like.

In embodiments of this application, “predefined” or “pre-configured” may be implemented by prestoring corresponding code, tables, or other forms that may be used to indicate related information in devices (for example, including an AP and an STA), and a specific implementation thereof is not limited in this application. For example, being pre-defined may refer to being defined in a protocol.

In embodiments of this application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of this application, the “include” may refer to direct inclusion, or may refer to indirect inclusion. Optionally, the term “include” mentioned in embodiments of this application may be replaced with “indicate” or “be used to determine”. For example, A including B may be replaced with that A indicates B, or A is used to determine B.

In embodiments of this application, sequence numbers of the foregoing processes do not mean execution sequences. The execution sequences of the processes should be determined according to functions and internal logic of the processes and should not be construed as any limitation on the implementation processes of embodiments of this application.

In embodiments of this application, the “protocol” may refer to a standard protocol in the communications field, and may include, for example, a WiFi protocol, and a related protocol applied to a future WiFi communications system, which is not limited in this application.

In several embodiments provided in this application, it should be understood that the disclosed system, apparatus, and method may be implemented in another manner. For example, the described apparatus embodiments are merely examples. For example, unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented by using some interfaces. Indirect couplings or communication connections between apparatuses or units may be implemented in electrical, mechanical, or other forms.

Units described as separate components may be or may not be physically separate, and components displayed as units may be or may not be physical units, that is, may be located in one position or may be distributed on a plurality of network units. Some or all of the units may be selected according to actual needs to achieve the objectives of solutions in embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (for example, a coaxial cable, an optical fiber, and a digital subscriber line (DSL)) manner or a wireless (for example, infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state disk (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A wireless communication method, comprising:
transmitting, by a first device, a first frame to a second device.

2. The method according to claim 1, wherein the first frame is a null data physical layer protocol data unit announcement NDPA frame of a first type; the NDPA frame comprises a fourth field; and the fourth field is used to indicate whether the NDPA frame is of the first type.

3. The method according to claim 2, wherein the NDPA frame further comprises a sounding dialog token field; and the fourth field immediately follows the sounding dialog token field.

4. The method according to claim 2, wherein the fourth field comprises a first station information field; and the NDPA frame is determined as an NDPA frame of the first type in a case that the NDPA frame comprises the first station information field.

5. The method according to claim 4, wherein the NDPA frame being determined as the NDPA frame of the first type in the case that the NDPA frame comprises the first station information field comprises:
the NDPA frame being determined as the NDPA frame of the first type in a case that the NDPA frame comprises the first station information field and that an NDPA variant field of a sounding dialog token field in the NDPA frame is set to 3.

6. The method according to claim 4, wherein in a case that an AID 11 field of a station information field in the NDPA frame is a first value, the station information field is the first station information field.

7. The method according to claim 6, wherein the first value is greater than or equal to 2007 and less than or equal to 2047.

8. The method according to claim 2, wherein in a case that an NDPA variant field of a sounding dialog token field in the NDPA frame is set to 3 and a first station information field appears, the NDPA frame is an NDPA frame of the first type.

9. A communications device, wherein the communications device is a first device, and the communications device comprises a memory and a processor, wherein the memory is configured to store a computer program and the processor is configured to execute the computer program stored in the memory to cause the communication device to perform an operation of:
transmitting a first frame to a second device.

10. The communications device according to claim 9, wherein the first frame is a null data physical layer protocol data unit announcement NDPA frame of a first type; the NDPA frame comprises a fourth field; and the fourth field is used to indicate whether the NDPA frame is of the first type.

11. The communications device according to claim 10, wherein the NDPA frame further comprises a sounding dialog token field; and the fourth field immediately follows the sounding dialog token field.

12. The communications device according to claim 10, wherein the fourth field comprises a first station information field; and the NDPA frame is determined as an NDPA frame of the first type in a case that the NDPA frame comprises the first station information field.

13. A communications device, wherein the communications device is a second device, and the communications device comprises a memory and a processor, wherein the memory is configured to store a computer program, and the processor is configured to execute the computer program stored in the memory to cause the communications device to perform an operation of:
receiving a first frame transmitted by a first device.

14. The communications device according to claim 13, wherein the first frame is a null data physical layer protocol data unit announcement NDPA frame of a first type; the NDPA frame comprises a fourth field; and the fourth field is used to indicate whether the NDPA frame is of the first type.

15. The communications device according to claim 14, wherein the NDPA frame further comprises a sounding dialog token field; and the fourth field immediately follows the sounding dialog token field.

16. The communications device according to claim 14, wherein the fourth field comprises a first station information field; and the NDPA frame is determined as an NDPA frame of the first type in a case that the NDPA frame comprises the first station information field.

17. The communications device according to claim 16, wherein the NDPA frame being determined as the NDPA frame of the first type in the case that the NDPA frame comprises the first station information field comprises:
the NDPA frame being determined as the NDPA frame of the first type in a case that the NDPA frame comprises the first station information field and that an NDPA variant field of a sounding dialog token field in the NDPA frame is set to 3.

18. The communications device according to claim 16, wherein in a case that an AID 11 field of a station information field in the NDPA frame is a first value, the station information field is the first station information field.

19. The communications device according to claim 18, wherein the first value is greater than or equal to 2007 and less than or equal to 2047.

20. The communication device according to claim 13, in a case that an NDPA variant field of a sounding dialog token field in the NDPA frame is set to 3 and a first station information field appears, the NDPA frame is an NDPA frame of the first type.
